(19) United States
(12) Patent Application Publication
(10) Pub. No.: US 2003/0207176 A1
(43) Pub. Date: Nov. 6, 2003

(54) Cathode for a lithium secondary battery comprising vanadium oxide as a cathode active material

(75) Inventors: Young Soo Yoon, Kwachon-Shi (KR); Won Il Cho, Seoul (KR); Byung Won Cho, Seoul (KR); Kyung Suk Yun, Seoul (KR); Hyung Jin Jung, Seoul (KR); Eun Jeong Jeon, Songnam-Shi (KR); Sang Cheol Nam, Seoul (KR); Young Hwa Shin, Songnam-Shi (KR)

Correspondence Address: DARBY & DARBY P.C., 805 Third Avenue, New York, NY, 10022, US

(73) Assignee: Korea Institute of Science and Technology

(21) Appl. No.: 09/770,990

(22) Filed: Jan. 26, 2001

(30) Foreign Application Priority Data
Jun. 12, 2000 (KR) 32150/2000

(51) Int. Cl. H01M 4/48; H01M 4/62

(52) U.S. Cl. 429/231.5; 429/232

(57) ABSTRACT

There is provided a cathode for a lithium secondary battery comprising vanadium oxide as a cathode active material and a conductive material stable in oxygen or sulfur atmosphere such as platinum, a conductive material stable in oxygen or sulfur atmosphere, particularly, platinum added to the vanadium oxide electrode contributes to structural stabilization of the vanadium oxide and to reduction of internal resistance, thereby improving conductivity and cycle in characteristic compared to vanadium oxide electrode without comprising such a conductive material. Accordingly, the cathode of the present invention can be used in various lithium secondary batteries including a thin film battery and bulk battery.

### FIELD OF THE INVENTION

The present invention relates to a cathode for a lithium secondary battery comprising vanadium oxide as a cathode active material, and more particularly, to a cathode for a lithium secondary battery comprising vanadium oxide and a conductive material stable in oxygen or sulfur atmosphere such as platinum.

### BACKGROUND OF THE INVENTION

With a recent development of micro-electronics, demands for minimizing a size, a weight and a thickness of a battery and a demand for increasing an energy density of it have been increasing. A lithium secondary battery, which uses metallic lithium or lithium alloy as its negative active material, has become the object of public attention for its high energy density and its small volume enough to supply sufficient energy to the compact and light-weight electronic devices. Not long before, the lithium secondary battery is expected to substitute Pb and Ni/Cd batteries. In addition, application of the lithium secondary battery would be extended to most of micro-electronic device as well as to light mobile communication instruments (for example, a cellular phone) or to a portable computer.

An initial lithium secondary battery had adopted lithium metal as an anode. However, a dendrite, formed on the lithium anode by the repetition of charging and discharging, resulted in degradation of efficiency of the battery, sometimes it resulted in the explosion by forming the short circuit.

In order to avoid the problem of forming the dendrite on a lithium anode, the various lithium secondary batteries have been developed that use a material which can intercalate and deintercalate lithium as an anode active material and/or a cathode active material.

As an anode active material to intercalate and deintercalate lithium, a carbonaceous material such as graphite, hard carbon or acetylene black has been used. As a typical cathode active material, LiCoO₂ is been widely used.

LiCoO₂, being widely used as a cathode active material for the commercially available lithium secondary battery, has advantageous that it has a high operating voltage and large capacity. The used of LiCoO₂ as a cathode active material however, is suffered from that cobalt is expensive, its reserves are relatively small, and it can cause the environmental pollution.

LiMn₂O₄ has been proposed as one of alternatives for LiCoO₂. Though capacity of LiMn₂O₄ is lower than that of LiCoO₂, it is superior to LiCoO₂ in view of the cost and environment.

Referring to a structure of LiCoO₂ and LiMn₂O₄ representative cathode active material, LiCoO₂ has a layered structure while LiMn₂O₄ has a spinel structure.

When used in a battery, both LiCoO₂ and LiMn₂O₄ exhibit an excellent performance when its crystallinity is high. Accordingly, in order to crystallize the materials, process of thermal treatment, is further required at the time of fabricating an electrode or after that, especially thin film battery is obtained. Therefore, it is impossible to apply them to a polymer (for example, plastic) for use in a medical purpose or other particular purpose, because the polymer can not tolerate the high temperature required for the thermal treatment.

In an effort to overcome the shortcomings of the above materials, there has been proposed vanadium oxide. In spite of low capacity, vanadium oxide exhibits favorable electrode characteristics, especially in an amorphous status. In addition, it is advantageous that vanadium oxide can be easily synthesized compared to the above materials, even at a room temperature. Further, amorphous vanadium oxide synthesized at a room temperature exhibited more powerful performance (for example, in terms of life cycle and efficiency) than crystalline vanadium oxide.

Therefore, if vanadium oxide is used as a cathode active material, a lithium secondary battery can be fabricated at a room temperature, which makes it be applied to the polymer for use in a medical purpose or other particular purpose such as plastic.

For this reason, vanadium oxide obtained by various chemical methods or a vacuum thin film method is expected to be widely used in a secondary battery as a cathode active material.

However, lithium secondary battery comprising vanadium oxide as a cathode active material has not been commercially available yet. It is believed that this comes from insufficient charging/discharging characteristic.

Factors determining the performance of a battery include a total energy storing capacity, an instantaneous output density, or a self-discharge rate. Especially in the secondary battery in which charging and discharging has taken place repeatedly, the capacity should not be much varied according to the cycle number of charging and discharging. This is called a cycle characteristic. With the development of super-fine electronics and semiconductor engineering, the life span of electronic appliance (or parts) has been prolonged, for which, improvement for the cycle performance of an energy source to drive those electronic appliance (or parts) are strongly demanded.

### SUMMARY OF THE INVENTION

Therefore, it is an object of the present invention to provide a vanadium oxide cathode having an improved cycle and capacity characteristic.

It is another object of the present invention to provide a lithium secondary battery comprising vanadium oxide as a cathode active material.

These and other objects of the present invention described in the detailed description can be achieved by providing a cathode comprising vanadium oxide as a cathode active material and a conductive material stable in oxygen or sulfur atmosphere such as platinum.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is is a schematic exemplary view of a system for use in fabricating a cathode for a lithium secondary battery in accordance with the present invention;

FIG. 2 illustrates a cycle characteristic of a platinum-added vanadium oxide thin film in accordance with the present invention;

FIG. 3 is an X-ray diffraction pattern of the vanadium oxide thin film in accordance with the present invention;

FIGS. 4A through 4D are photographs of surface of the platinum-added vanadium oxide thin film in accordance with the present invention; and

FIG. 5 illustrates a cycle characteristic of a cooper-added vanadium oxide battery.

### DETAILED DESCRIPTION OF THE PREFERRED EMBODIMENTS

The present invention will now be described in detail with reference to the accompanying drawings.

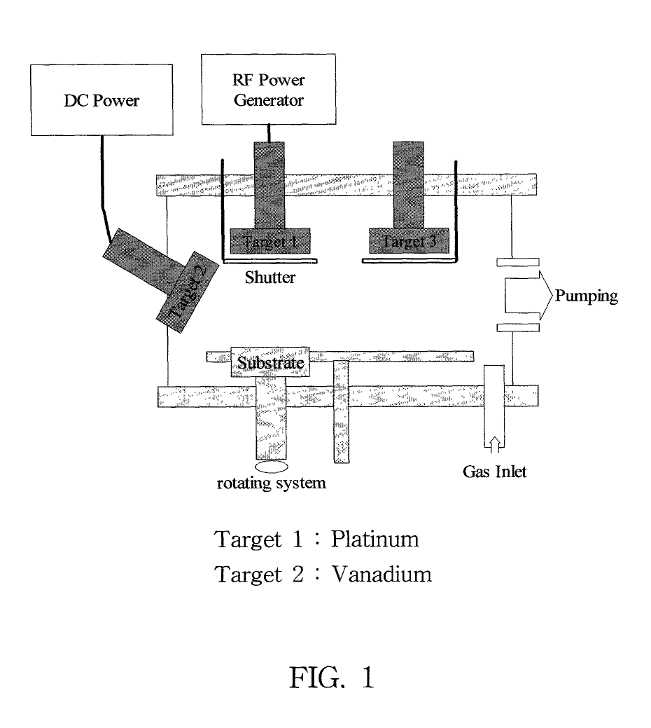

FIG. 1 is a schematic exemplary view of a system for use in fabricating a cathode for a lithium secondary battery in accordance with the present invention.

A DC reactive sputtering was used to deposit vanadium oxide on a substrate such that vanadium oxide thin film was formed, RF (radio-frequency) reactive sputtering was used to sputter platinum, and in-situ process was adopted. That is, After two 4-inch targets was respectively equipped below two sputtering guns, one is for metal vanadium and the other is for platinum, platinum was added while deposition of the vanadium oxide on the substrate was performed. As a substrate upon which vanadium oxide thin film was deposited, a silicon wafer was used on which a platinum thin film had been deposited as a current collector at a room temperature.

The degree of vacuum of the vacuum reactive reservoir was initially 5×10⁻⁶ torr, and the degree of vacuum during fabrication of the thin film was 5×10⁻³ torr. The ratio of oxygen to argon was 20:80, and total gas flow was adjusted to an amount of 100 cc (100 sccm) per minute.

In order to remove contaminants from the surface of the thin film, both vanadium and platinum targets were presputterred for 20 minutes prior to performing deposition of the vanadium oxide thin film. During deposition, the substrate was rotated at a speed of 5.5 rpm so that a thin film with uniform thickness was obtained.

In the above method, platinum and vanadium oxide was separately introduced. However, they can be introduced in a various form. For example, mixture or alloy of platinum and vanadium oxide can be used as a source of platinum and vanadium oxide. That is, the sputtering target can be filled with V (or V₂O₅)—Pt alloy.

In addition, in the above Example, sputtering was used to fabricate platinum-added vanadium oxide electrode. However, it would be obvious to skilled persons in the art to which said subject matter pertains that platinum may be included in vanadium oxide electrode by using various methods: a physical vapor deposition such as a heat deposition, an electron beam deposition, an ion beam deposition and a laser ablation; a chemical vapor deposition (CVD) such as a low pressure- and high pressure-CVD, plasma-assistant CVD, an organometallic-CVD; a sol-gel method; spin coating; and electrostatic spray deposition.

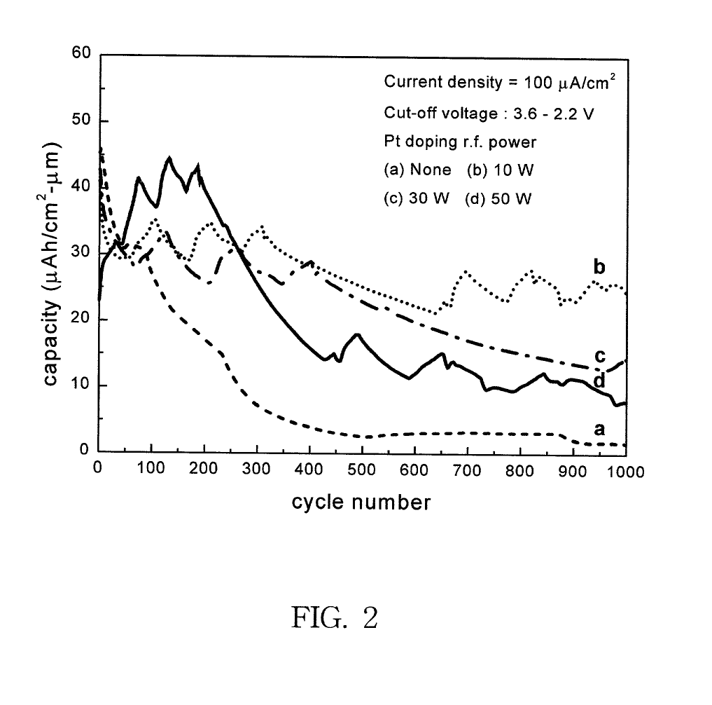

Using the platinum-added vanadium oxide electrode fabricated by sputtering as a cathode, cycle characteristic was measured and the results was shown in FIG. 2.

For the purpose of comparison with the battery of vanadium oxide cathode of the present invention, a cycle characteristic of a vanadium electrode that does not contain platinum was also measured, the results was also shown in FIG. 2. In this respect, a metallic lithium thin film was used as a counter and reference electrode, porous polypropylene as a separator and 1 M LiPF₆ EC solution as an electrolyte. In addition, a static-current system was used in the measurement of a battery characteristic in which current density was 100 μA/cm².

FIG. 2 showed that cycle characteristic of the battery comprising the platinum-doped vanadium oxide electrode as a cathode of the present invention has been greatly improved, which is compared to the battery comprising vanadium oxide electrode that does not contain platinum. Besides, it also showed that the capacity of the battery comprising the platinum-doped vanadium oxide electrode as a cathode has been upgraded. This result was notable, because incorporation of a common metallic element to vanadium oxide for improving the cycle characteristic has reduced the capacity of battery. This means that platinum-doped vanadium oxide cathode is much better than the pure vanadium oxide cathode, and than a common metal-added vanadium oxide electrode. It is believed that such unexpected improvements is caused by platinum's contribution to the conductivity by reducing the internal resistance of the electrode as well as structural stabilization of vanadium oxide, compared to a common metallic element that is used just to improve the structural stabilization of vanadium oxide.

FIG. 2 merely shows the cycle characteristic of the platinum-added vanadium oxide electrode, but the conductive material stable in oxygen or sulfur atmosphere, such as Pd, Au, Ir, Ru, super-conductive material oxide or conductive material oxide showed the similar result.

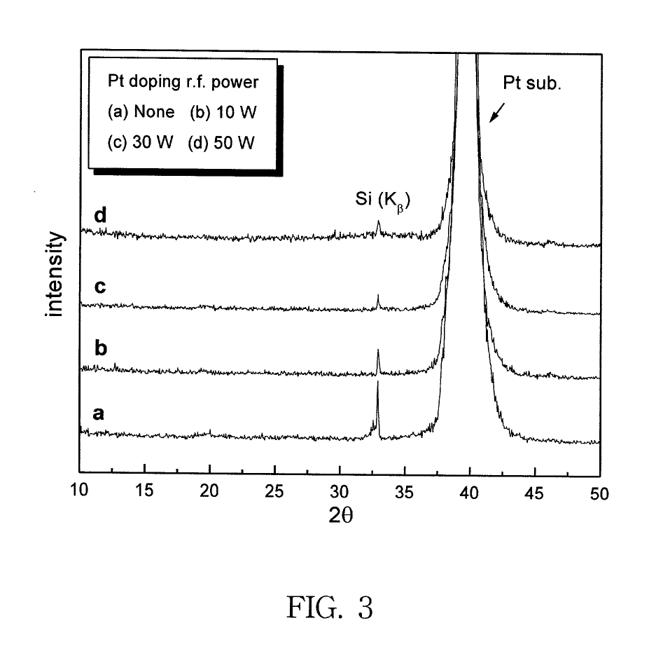

In FIG. 3, X-ray diffraction patterns of the platinum-added vanadium oxide thin film in accordance with the present invention as well as the vanadium oxide thin film that does not contain platinum was showed. As shown in FIG. 3, there was no peak of crystalline material other than that of platinum. Accordingly, the platinum-added vanadium oxide thin film has an amorphous structure and the amorphous vanadium oxide was deposited.

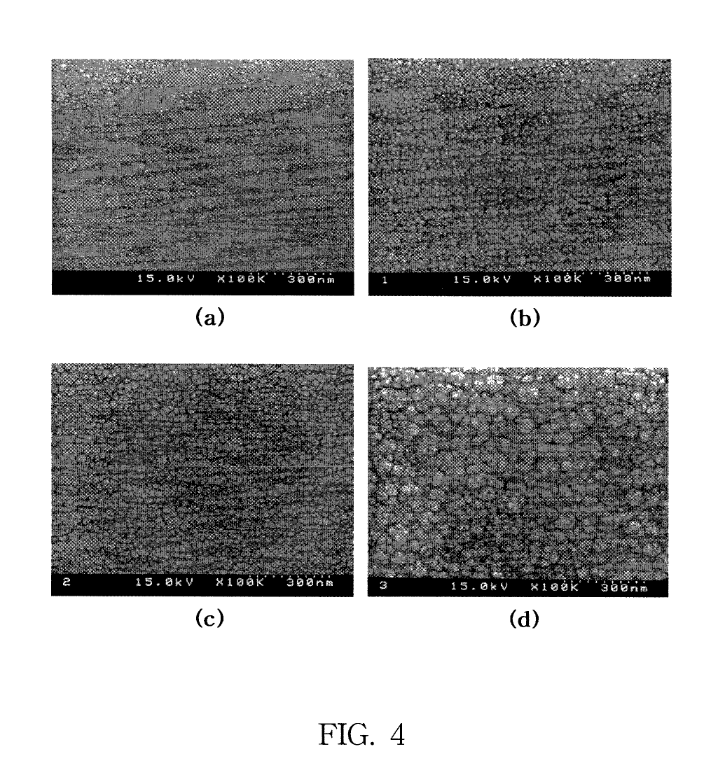

FIGS. 4A through 4D are photographs of surface of the platinum-added vanadium oxide thin film in accordance with the present invention, wherein the amount of platinum added was successively increased. With the increase in the amount of platinum added, the particle size has increased. But, any significant defect was not observed such as surface cracking or the formation of pore. This signifies that doping of platinum does not adversely affect on the fine structure of the thin film at the time of fabrication of the vanadium oxide thin film.

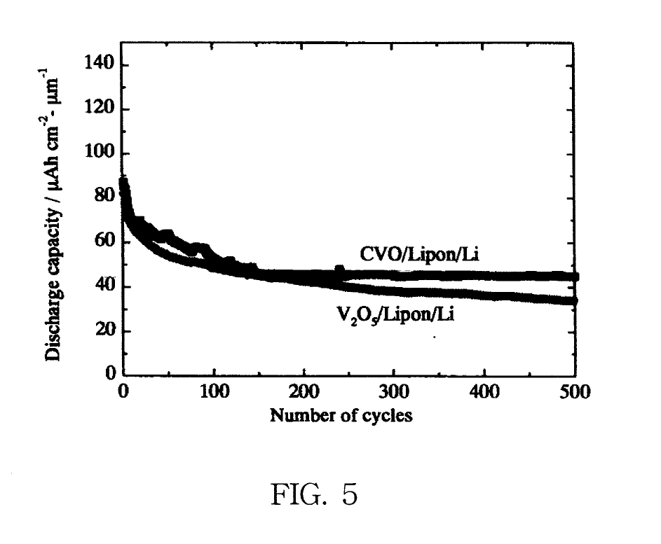

FIG. 5 illustrates cycle characteristic of battery comprising vanadium oxide as a cathode active material and copper, one of the conductive materials stable in oxygen or sulfur atmosphere, and which shows that the capacity of the cooper-added vanadium oxide electrode is stable and high even after 150 cycles.

As so far described, a electrode for use in lithium secondary batteries comprising vanadium oxide as a cathode active material to which a conductive material stable in oxygen or sulfur atmosphere, particularly, platinum, was added exhibited the improved conductivity and significantly improved cycle characteristic, compared to the vanadium oxide electrode which does not contain such a conductive material.

Accordingly, the vanadium oxide electrode of the present invention can be used as a cathode for various lithium secondary batteries, and the cathode for a lithium secondary battery can be used to various lithium secondary batteries including a thin film battery and bulk battery.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A cathode for a lithium secondary battery comprising:
a) vanadium oxide as a cathode active material; and,
b) a conductive material stable in oxygen or sulfur atmosphere.

2. The cathode according to claim 1, wherein the conductive material is at least one selected from the group consisting of Pt, Pd, Au, Ir, Ru, super-conductive material oxide and conductive material oxide.

3. The cathode according to claim 1, wherein the conductive material is Pt.

4. The cathode according to claim 1, wherein the conductive material is added by sputtering, a physical vapor deposition including a heat deposition, an electron beam deposition, an ion beam deposition and a laser ablation, a chemical vapor deposition (CVD) including a low pressure- and high pressure-CVD, plasma-assistant CVD and an organometallic-CVD, a sol-gel method, spin coating, and electrostatic spray deposition.

5. The cathode according to claim 4, wherein the conductive material is Pt.

6. The cathode according to claim 4, wherein platinum and vanadium oxide were separately introduced.

7. The cathode according to claim 4, wherein platinum and vanadium oxide were introduced in the form of V (or V₂O₅)—Pt alloy.

8. A lithium secondary battery comprising the cathode according to claim.
